(19) United States
(12) Patent Application Publication
(10) Pub. No.: US 2026/0171845 A1
(43) Pub. Date: Jun. 18, 2026

(54) WIRELESS CHARGER

(71) Applicant: GOPOD GROUP HOLDING LIMITED., SHENZHEN (CN)

(72) Inventors: Zhuowen LIAO, SHENZHEN (CN); Xingwang SONG, SHENZHEN (CN); Long MIAO, SHENZHEN (CN)

(21) Appl. No.: 19/009,992

(22) Filed: Jan. 4, 2025

(30) Foreign Application Priority Data
Dec. 16, 2024 (CN) 202423111269.5

(51) Int. Cl. H02J 50/10; H02J 50/00; H02J 50/90

(52) U.S. Cl. CPC H02J 50/10; H02J 50/005; H02J 50/90

(57) ABSTRACT

Disclosed is a wireless charger, which comprises a shell (10), an extension channel (11) and a charging assembly (20), the extension channel (11) is arranged on a side surface of the shell (10), the charging assembly (20) is arranged in the shell (10), the charging assembly (20) wirelessly charges an electronic device, the charging assembly (20) is electrically connected with an external power supply through a power supply wire (30) extending out of the extension channel (11), the extension channel (11) extends away from the charging assembly (20) by a certain distance, and a structure of the extension channel is set according to a shape of a charging cable and requirements of a user, so as to accommodate and guide the power supply wire (30), thus restricting a position of the power supply wire (30).

### TECHNICAL FIELD

The present invention relates to the field of accessories, and particularly, to a wireless charger.

### BACKGROUND OF THE PRESENT INVENTION

With the wide application of wireless charging technology, wireless charger has become an indispensable charging device in daily life. A charging coil is arranged in the wireless charger, and based on the principle of electromagnetic induction line, the wireless charger may supply power to an electronic device without connection, and the charging coil arranged in the wireless charger is generally electrically connected with a charging head (that is, an adapter) or a power supply through a charging cable.

According to existing wireless chargers, the charging cable often has no fixed position, and is easy to be wound and scattered, which is inconvenient to use and unsightly, and affects user experience. In some prior arts, this problem is solved by designing an independent storage, but these apparatuses usually need additional accessories, which increases the cost and volume, is complicated to use or occupies more space, and makes the shell fail to make full use of space, resulting in waste of resources.

Moreover, existing charging cable interfaces are usually exposed to provide charging experience for mobile devices. As shown in FIG. 1, a single opening or a simple interface design is used to connect a power supply, this design may not only lead to the loosening or damage of the charging cable during use, but also easily cause disturbance by external environment such as dust and water vapor due to the exposure of the interface, so that the long-term use may lead to the performance degradation or even damage of the interface, thus affecting a normal charging function of the device.

### SUMMARY OF THE PRESENT INVENTION

The present invention is mainly intended to provide a wireless charger, and aims to solve the above problems of scattering and use inconvenience of power supply wire of existing shell, insufficient utilization of shell, and the like. The wireless charger comprises:
a shell;
an extension channel, wherein the extension channel is arranged on a side surface of the shell; and
a charging assembly, wherein the charging assembly is arranged in the shell, the charging assembly is used for wirelessly charging an electronic device, and the charging assembly is electrically connected with an external power supply through a charging cable extending out of the extension channel.

Optionally, the extension channel extends away from the shell by a first length.

Optionally, the shell and the extension channel are in an integrated structure.

Optionally, the shell comprises a bottom shell and a face shell, one surface of the bottom shell is provided with an opening, the face shell and the bottom shell are connected with each other at the opening to form an accommodating cavity, and the extension channel is arranged on a side wall of the bottom shell and communicated with the accommodating cavity.

Optionally, the bottom shell is provided with a vent, and the vent is arranged on a side wall or a bottom wall of the bottom shell.

Optionally, the wireless charger further comprises a power supply wire, one end of the power supply wire is electrically connected with the charging assembly in the shell, and the other end of the power supply wire passes through the extension channel and extends out of the shell to be electrically connected with the external power supply.

Optionally, the wireless charger further comprises a supporting plate, the supporting plate is arranged in the accommodating cavity, the supporting plate is provided with an interface mounting position, and the power supply wire is arranged in the interface mounting position and structurally adapted to the interface mounting position.

Optionally, the charging assembly further comprises a coil, a magnet and a circuit board, the circuit board is arranged on one side of the supporting plate and closely attached to the supporting plate, the coil and the magnet are arranged on the other side of the supporting plate, the supporting plate is provided with a partition plate, the partition plate separates the coil and the magnet, and the magnet is on an outer side of the coil.

Optionally, the wireless charger further comprises heat dissipation fan blades, and the heat dissipation fan blades are arranged on the supporting plate and located in a central region of the circuit board.

Optionally, a central region of the supporting plate is provided with a sunken groove, the heat dissipation fan blades are arranged in the sunken groove 43, the circuit board is hollow, and the circuit board is laid on a periphery of the sunken groove, so that the heat dissipation fan blades are opposite to an inner side wall of the circuit board.

The wireless charger of the present invention consists of the shell and the charging assembly, wherein the charging assembly is arranged inside the shell, the electronic device is placed on the shell, the charging assembly realizes the function of wirelessly charging the electronic device, the shell is provided with the extension channel, the structure of the extension channel is set according to a shape of the charging cable and requirements of a user, the extension channel is arranged on the side surface of the shell and extends away from the charging assembly by a certain distance, which provides a channel for the charging cable to pass through, the charging cable extends from the extension channel and is connected with the external power supply, the extension channel also accommodates and guides the charging cable, which restricts the position of the charging cable, and the charging cable can be fixed in a proper position and distributed along the extension channel, which avoids a winding phenomenon in a use process, and makes the user easily find the charging cable and connect the charging cable with the external power supply, and therefore, the service life and use convenience of the wire are improved, the user experience is enhanced, and compared with a traditional charging interface, the charging interface is also prevented from being exposed to dust and water, so as to make the wireless charger more durable and safer.

### DESCRIPTION OF THE DRAWINGS

In order to illustrate technical solutions in embodiments of the present invention or in the prior art more clearly, the drawings to be used in the descriptions of the embodiments or the prior art will be briefly described hereinafter. Obviously, the drawings in the following descriptions are merely some embodiments of the present invention, and for those of ordinary skills in the art, other drawings may also be obtained based on the structures shown in these drawings without going through any creative work.

FIG. 1 is a schematic diagram of an interface of an existing charging device;

FIG. 2 is a schematic diagram of a cross section of a wireless charger 100 of the present invention;

FIG. 3 is an exploded view of a partial structure of the wireless charger 100 of the present invention;

FIG. 4 is a schematic structural diagram of a supporting plate 40 in the wireless charger 100 of the present invention;

FIG. 5 is an exploded view of the wireless charger 100 of the present invention;

FIG. 6 is a schematic structural diagram of a bottom shell 12 in the wireless charger 100 of the present invention; and

FIG. 7 is a schematic structural diagram of the wireless charger 100 of the present invention from one perspective.

### DESCRIPTION OF REFERENCE NUMERALS

| Numeral | Name | Numeral | Name |
|---|---|---|---|
| 100 | Wireless charger | 22 | Magnet |
| 10 | Shell | 23 | Circuit board |
| 11 | Extension channel | 30 | Power supply wire |
| 12 | Bottom shell | 40 | Supporting plate |
| 121 | Vent | 41 | Interface mounting position |
| 13 | Face shell | 42 | Partition plate |
| 20 | Charging assembly | 43 | Sunken groove |
| 21 | Coil | 50 | Heat dissipation fan blade |

The achievement of objectives, the functional features and the advantages of the present invention will be further described with reference to the drawings and the embodiments.

### DETAILED DESCRIPTION OF PREFERRED EMBODIMENTS

Technical solutions in embodiments of the present invention will be clearly and completely described hereinafter with reference to the drawings in the embodiments of the present invention. Obviously, the described embodiments are only some but not all of the embodiments of the present invention. Based on the embodiments of the present invention, all other embodiments obtained by those of ordinary skills in the art without going through any creative work shall fall within the scope of protection of the present invention.

It shall be noted that all directional indications (such as upper, lower, left, right, front, rear, etc.) in the embodiments of the present invention are only used to explain the relative positional relationship, movement condition, etc. among various components under a certain specific posture (as shown in the drawings), and if the specific posture is changed, the directional indications are also changed accordingly.

Moreover, the descriptions related to “first”, “second”, etc. in the present invention are used for descriptive purposes only and cannot be understood as indicating or implying relative importance, or implicitly indicating the number of technical features indicated thereby. Thus, the feature defined by “first” and “second” may explicitly or implicitly comprise at least one feature. In addition, the technical solutions in the embodiments can be combined with each other, which shall be on the basis that the combination can be realized by those of ordinary skills in the art, when the combination of the technical solutions is contradictory or cannot be realized, it shall be considered that the combination of the technical solutions does not exist and does not fall within the scope of protection of the present invention.

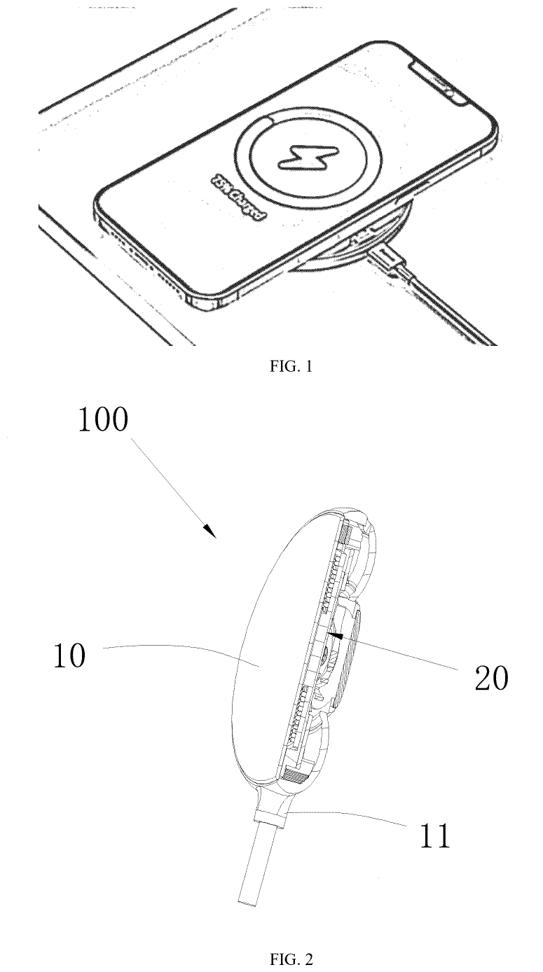

A wireless charger may generate a magnetic field by internally arranging a transmitting end coil, and an electronic device provided with a receiving end coil induces a change of the magnetic field to generate a current, so that the electronic device may be charged without using a charging cable, which is very convenient. An existing wireless charger is as shown in FIG. 1, power still needs to be supplied to the existing wireless charger by connecting a power supply, and the scattering or untidiness of a power supply wire in a use process may affect the user experience, and may also cause damage to the wireless charger, so that how to store and use the power supply wire of the wireless charger still needs to be improved.

The present invention provides a wireless charger 100. With reference to FIG. 2, the wireless charger 100 comprises a shell 10 and a charging assembly 20, wherein the charging assembly 20 is arranged inside the shell 10 and used for wirelessly charging an electronic device, and the shell 10 is provided with an extension channel 11. A structure of the extension channel 11 is set according to a shape of a power supply wire 30 and requirements of a user. For example, when the power supply wire is set to be cylindrical and square, the extension channel 11 is arranged on a side surface of the shell 10 and extends away from the charging assembly 20 by a first length, and the first length may be set according to actual needs to provide a channel for the power supply wire 30 to pass through. The power supply wire 30 extends from the extension channel 11 and is connected with an external power supply, the extension channel 11 also accommodates and guides the power supply wire 30, which restricts a position of the power supply wire 30, and the power supply wire 30 can be fixed in a proper position and distributed along the extension channel 11, which avoids a winding phenomenon in a use process, and makes the user easily find the power supply wire 30 and connect the power supply wire with the external power supply. Therefore, the user experience is enhanced, and compared with a traditional charging interface, the charging interface is also prevented from being exposed to dust and water, so as to improve the service life and use convenience of the wireless charger 100, and make the wireless charger 100 more durable and safer.

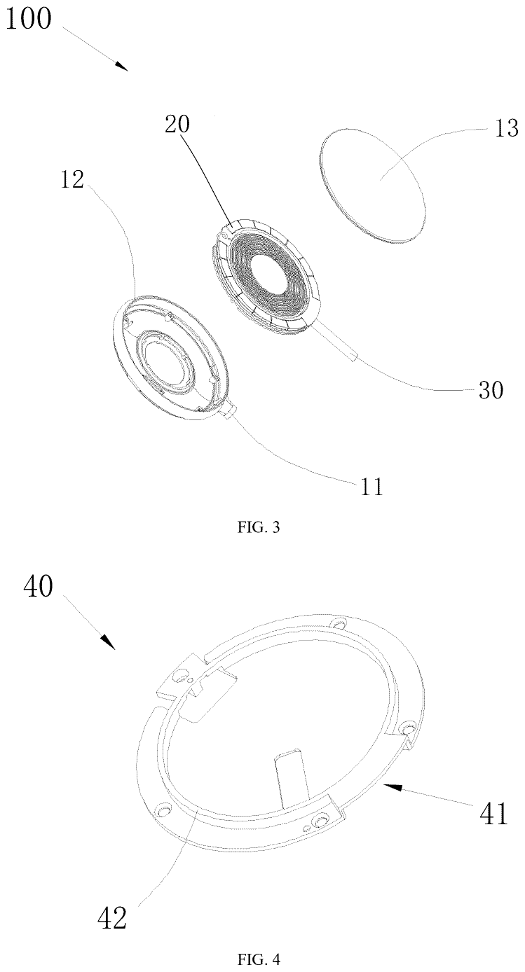

With reference to FIG. 3, the shell 10 comprises a bottom shell 12 and a face shell 13, and the face shell 13 is set to be circular. The user places the electronic device on the face shell 13 for charging, and the bottom shell 12 is set to be in a circular hollow structure formed by bending a periphery. One surface of the bottom shell 12 is provided with an opening, the bottom shell 12 is placed on a plane, and the bottom shell 12 and the face shell 13 are connected with each other at the opening to form an accommodating cavity. The charging assembly 20 is arranged in the accommodating cavity, the extension channel 11 is arranged on a side surface of the bottom shell 12, and integrated with the bottom shell 12, the extension channel 11 is communicated with the accommodating cavity, and the power supply wire 30 is connected to the charging assembly 20.

Further, with reference to FIG. 4 and FIG. 5, the wireless charger 100 further comprises a supporting plate 40, and the supporting plate 40 is arranged in a central position of the accommodating cavity to divide the accommodating cavity into two layers. The charging assembly 20 comprises a coil 21, a magnet 22 and a circuit board 23, and the coil 21 and the magnet 22 are arranged on one side of the supporting plate 40, located in one layer of the accommodating cavity, and located between the supporting plate 40 and the face shell 13. One surface of the supporting plate 40 oriented to the bottom shell 12 is provided with a partition plate 42, the partition plate 42 separates the coil 21 and the magnet 22, the coil 21 is arranged in the partition plate 42, and the magnet 22 is arranged on a periphery of the coil 21, so that the electronic device is attracted to be aligned with the coil 21 and then the electronic device is charged. The circuit board 23 is arranged on the other side of the supporting plate 40, located in the other layer in the accommodating cavity, closely attached to the supporting plate 40, and located between the bottom shell 12 and the supporting plate 40. This structure makes full use of a space between the supporting plate 40, and the bottom shell 12 and the face shell 13, which improves a utilization rate of the accommodating cavity, and can make the whole wireless charger 100 thinner.

Based on the above embodiment, the wireless charger 100 further comprises the power supply wire 30, and the power supply wire 30 is used for connecting the external power supply and the charging assembly 20. The supporting plate 40 is provided with an interface mounting position 41 adapted to the structure of the power supply wire 30 in a position corresponding to the extension channel 11, one surface of the interface mounting position 41 oriented to the face shell 13 protrudes, and the power supply wire 30 is arranged in the interface mounting position 41 and electrically connected with the circuit board 23, and extends out of the extension channel 11 to be connected with the external power supply, so as to drive the coil 21 to generate an electromagnetic field to charge the electronic device.

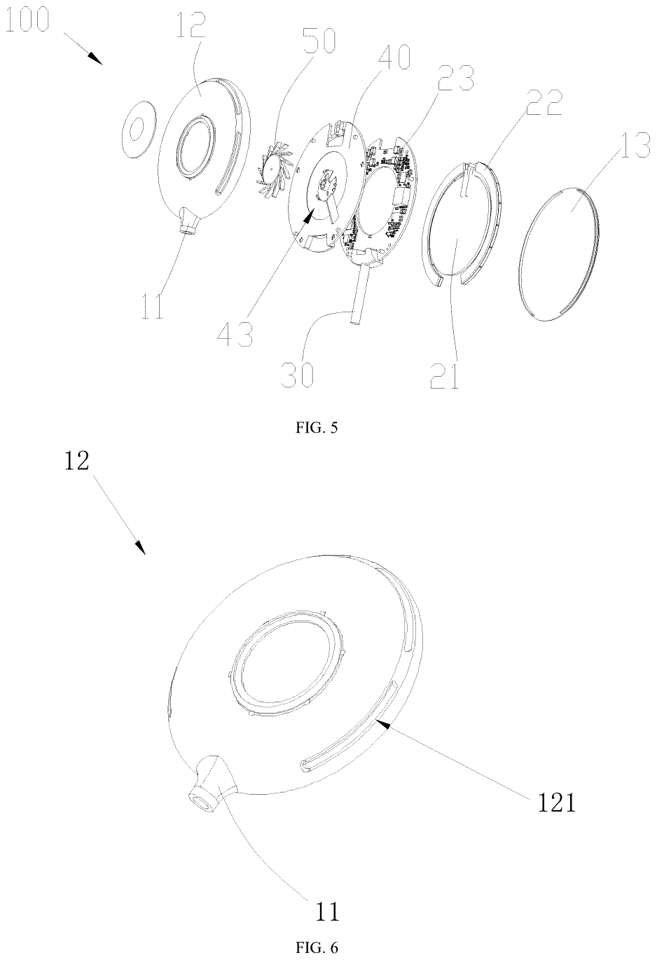

Preferably, the circuit board 23 is in a circular structure with a hollow interior, a central region of the supporting plate 40 is provided with a sunken groove 43, the circuit board 23 is laid on a periphery of the sunken groove 43, electronic components on the circuit board 23 are distributed around, and heat dissipation fan blades 50 are arranged in the sunken groove 43 and connected with the supporting plate 40, so that the heat dissipation fan blades 50 are opposite to an inner side wall of the circuit board 23. This structure makes full use of the structure of the supporting plate 40, so that an overall structure is very thin while the accommodating cavity accommodates the heat dissipation fan blades 50. When the heat dissipation fan blades 50 rotate, air inside the accommodating cavity flows to cool the whole scope of the circuit board 23. Moreover, the heat dissipation fan blades 50 are directly mounted on the supporting plate 40 without being provided with a shell, which makes more reasonable use of the space of the accommodating cavity. With reference to FIG. 6, a side wall and a bottom portion of the bottom shell 12 are provided with vents 121, and the vent 121 in the bottom portion of the bottom shell 12 is arranged in a center of the bottom shell 12, and corresponds to the heat dissipation fan blades 50, so as to better cooperate with the heat dissipation fan blades 50 to dissipate heat. The bottom portion of the bottom shell 12 is sunken from the periphery to the vent 121 at the center, so that when the bottom shell 12 is placed on a plane, a space is left between the bottom shell 12 and the plane, which facilitates better flow and discharge of air inside the accommodating cavity, thus dissipating heat of the circuit board 23.

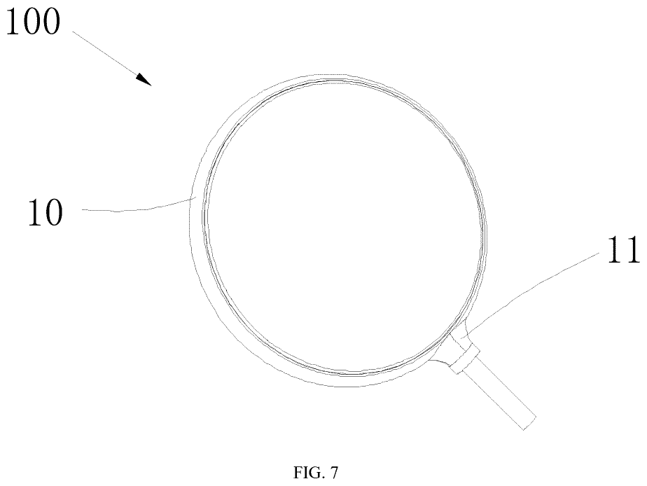

FIG. 7 shows that when the wireless charger 100 is placed on a plane, the face shell is oriented to the user, and by arranging the shell 10 and the supporting plate 40, the circuit board 23, the coil 21, the magnet 22 and the heat dissipation fan blades 50 are encapsulated in the accommodating cavity. The circuit board 23, the coil 21 and the magnet 22 are closely connected with the supporting plate 40, and the supporting plate 40 and the shell 10 may be fastened by a screw and the like. Moreover, the heat dissipation fan blades 50 and the circuit board are arranged on one side of the supporting plate 40, the heat dissipation fan blades 50 are arranged in the sunken groove 43, and the coil 21 and the magnet 22 are arranged on the other side of the supporting plate 40, so that the whole structure is mounted compactly. The bottom shell 12 is provided with a decorative piece, the shell 10 not only provides support for the whole structure, but also makes the device beautiful as a whole, the extension channel 11 arranged at the bottom shell 12 stores and protects the power supply wire 30, and the power supply wire 30 extends out of the extension channel 11, so that the power supply wire 30 is distributed along the extension channel 11, and fixed at the bottom portion of the wireless charger 100, thus being easy to take when in use. After the power supply wire 30 is connected to the external power supply, circuit operation of the circuit board 23 drives the coil 21 to generate the electromagnetic field, the electronic device is placed on the face shell 13, and the wireless charger 100 is aligned with the electronic device through the magnet 22, so as to realize wireless charging. A fan assembly mounted on the supporting plate 40 dissipates the heat of the circuit board, promotes the air in the accommodating cavity to flow, and prevents the temperature from being too high during charging, thus providing good user experience.

The above are merely preferred embodiments of the present invention, but are not intended to limit the patent scope of the present invention. Under the conception of the present invention, all equivalent structural transformations made by using the specification of the present invention and the contents of the drawings, or used directly/indirectly in other related technical fields, are included in the scope of protection of the present invention.

We claim:

1. A wireless charger (100), wherein the wireless charger (100) comprises:
a shell (10);
an extension channel (11), wherein the extension channel (11) is arranged on a side surface of the shell (10); and used for accommodating a power supply wire (30); and
a charging assembly (20), wherein the charging assembly (20) is arranged in the shell (10), the charging assembly is used for wirelessly charging an external electronic device, and the charging assembly (20) is electrically connected with an external power supply through the power supply wire (30) accommodated in the extension channel (11).

2. The wireless charger (100) according to claim 1, wherein the extension channel (11) extends away from the shell (10) by a first length.

3. The wireless charger (100) according to claim 1, wherein the shell (10) and the extension channel (11) are in an integrated structure.

4. The wireless charger (100) according to claim 1, wherein the shell (10) comprises a bottom shell (12) and a face shell (13), one surface of the bottom shell (12) is provided with an opening, the face shell (13) and the bottom shell (12) are connected with each other at the opening to form an accommodating cavity, and the extension channel (11) is arranged on a side wall of the bottom shell (12) and communicated with the accommodating cavity.

5. The wireless charger (100) according to claim 1, wherein the wireless charger (100) further comprises the power supply wire (30), one end of the power supply wire (30) is electrically connected with the charging assembly (20) in the shell (10), and the other end of the power supply wire (30) passes through the extension channel (11) and extends out of the shell (10) to be electrically connected with the external power supply.

6. The wireless charger (100) according to claim 5, wherein the wireless charger (100) further comprises a supporting plate (40), the supporting plate (40) is arranged in the accommodating cavity, the supporting plate (40) is provided with an interface mounting position (41), and the power supply wire (30) is arranged in the interface mounting position (41) and structurally adapted to the interface mounting position (41).

7. The wireless charger (100) according to claim 6, wherein the charging assembly (20) further comprises a coil (21), a magnet (22) and a circuit board (23), the circuit board (23) is arranged on one side of the supporting plate (40) and closely attached to the supporting plate (40), the coil (21) and the magnet (22) are arranged on the other side of the supporting plate (40), one side of the supporting plate (40) provided with the coil (21) and the magnet (22) is provided with a partition plate (42), the partition plate (42) separates the coil (21) and the magnet (22), and the magnet (22) is on an outer side of the coil (21).

8. The wireless charger (100) according to claim 7, wherein the wireless charger (100) further comprises heat dissipation fan blades (50), the heat dissipation fan blades (50) are arranged on the supporting plate (40) and located in a central region of the circuit board (23), and electronic components in the circuit board (23) are distributed on a periphery of the heat dissipation fan blades (50).

9. The wireless charger (100) according to claim 8, wherein the bottom shell (12) is provided with a vent (121), a side wall of the bottom shell (12) has a first height, and the vent (121) is arranged in the side wall or a bottom wall of the bottom shell (12); and the heat dissipation fan blades (50) drive gas in the shell (10) to flow out through the vent (121).

10. The wireless charger (100) according to claim 8, wherein a central region of the supporting plate (40) is provided with a sunken groove (43), the heat dissipation fan blades (50) are arranged in the sunken groove (43), the circuit board (23) is hollow, and the circuit board (23) is laid on a periphery of the sunken groove (43), so that the heat dissipation fan blades (50) are opposite to an inner side wall of the circuit board (23).
